(19) United States
(12) Patent Application Publication
(10) Pub. No.: US 2001/0036894 A1
(43) Pub. Date: Nov. 1, 2001

(54) Ceramic compositions

(75) Inventors: Kassim Juma, Stafford (GB); Sumihiko Kurita, Saga-ken (JP)

Correspondence Address: Nixon & Vanderhye P.C., 8th Floor, 1100 N. Glebe Road, Arlington, VA, 22201, US

(73) Assignee: Foseco International Limited

(21) Appl. No.: 09/867,534

(22) Filed: May 31, 2001

Related U.S. Application Data
(63) Continuation of application No. 09/214,128, filed on Jan. 11, 1999.
Application No. 09/214,128 is a 371 of international application No. PCT/GB97/01706, filed on Jun. 24, 1997.

(30) Foreign Application Priority Data
Jul. 5, 1996 (GB) 9614188.2

(51) Int. Cl. C04B 35/00

(52) U.S. Cl. 501/96.4; 501/96.3

(57) ABSTRACT

Ceramic compositions which are of particular value in the handling or casting of steel, for example as lining materials or for producing nozzles or shrouds used in continuous casting, comprise a mixture of particles of boron nitride, zirconium diboride and at least one other refractory material, bonded together by carbon produced by the decomposition of an organic binder such as a resin or pitch. The other refractory material may be for example a refractory metal, an oxide, a carbide, a boride or a nitride. Zirconium oxide containing compositions comprising 5-70% by weight boron nitride, 5-60% by weight zirconium diboride and 5-80% by weight of zirconium oxide are particularly suitable for forming at least that part of a nozzle which in use is at the slag line in a molten steel vessel. Aluminum oxide containing compositions comprising 5-70% by weight boron nitride, 15-50% by weight zirconium diboride and 10-70% by weight aluminum oxide are particularly suitable for forming the inside of nozzles as they resist alumina build up and prevent clogging of the nozzles.

This invention relates to ceramic compositions which are of particular value in the handling and casting of high melting temperature metals such as iron or steel.

It is common practice to make articles, which are used in the handling and casting of molten metals such as steel, from carbon bonded ceramics (also known as black refractories). Examples of such articles are pouring nozzles for molten metal-containing vessels such as ladles or tundishes, and shrouds which surround the metal stream flowing from one vessel to another. These carbon bonded ceramics are formed from a mixture of graphite, one or more oxides such as alumina, magnesia and zirconia, and a binder such as a phenolic resin or pitch which will decompose to produce a carbon bond.

The above carbon bonded ceramic materials suffer from a number of disadvantages. They have poor thermal shock resistance and tend to crack, so that it is necessary to treat articles such as nozzles and shrouds in some way so as to minimise the thermal shock produced when the articles are heated rapidly to elevated temperatures. The materials also have low oxidation resistance as they contain a relatively high proportion of carbon, mainly in the form of graphite. The materials also suffer from additional disadvantages in specific applications. For example, the outer surface of a nozzle is susceptible to attack by slag present on the surface of the molten metal in which the nozzle is immersed (known as slag line attack), and the bore of a nozzle tends to become clogged in use due to the build up of alumina, when casting aluminium killed steel.

It has now been found that a carbon bonded ceramic material consisting of a mixture of boron nitride, zirconium diboride and at least one other refractory material, is particularly useful as an alternative to conventional graphite-containing carbon bonded ceramics for the production of articles used for the handling and casting of molten metals, such as steel.

According to a first feature of the invention there is provided a ceramic composition comprising a mixture of particles of boron nitride, zirconium diboride and at least one other refractory material bonded together by carbon produced by the decomposition of an organic binder.

The other refractory material may be for example a refractory metal, an oxide, a carbide, a boride or a nitride.

The refractory metal may be for example boron.

Examples of suitable refractory oxides include aluminium oxide, zirconium oxide, magnesium oxide, yttrium oxide, calcium oxide, chromium oxide and silicon oxide. More than one oxide may be used, and the oxide may be a mixed refractory oxide such as mullite.

Examples of suitable carbides include silicon carbide, boron carbide, aluminium carbide and zirconium carbide. More than one carbide may be used.

Examples of suitable borides include titanium diboride and calcium hexaboride, and examples of suitable nitrides include silicon nitride, aluminium nitride, titanium nitride, zirconium nitride and sialon. More than one boride and more than one nitride may be used.

According to one preferred embodiment of the invention the ceramic composition comprises a mixture of boron nitride, zirconium diboride and zirconium oxide, and the ceramic composition preferably contains 5-70% by weight of boron nitride, more preferably 15-50% by weight, 5-60% by weight of zirconium diboride, more preferably 15-50 % by weight, and 5-80% by weight of zirconium oxide, more preferably 10-60% by weight.

According to another preferred embodiment of the invention the ceramic composition comprises a mixture of boron nitride, zirconium diboride and aluminium oxide, and the ceramic composition preferably contains 5-70% by weight of boron nitride, more preferably 15-50% by weight, 5-60% by weight of zirconium diboride, more preferably 15-50 % by weight, and 10-70% by weight of aluminium oxide, more preferably 15-60% by weight.

In the above preferred embodiments the proportion of each of the components of the ceramic composition is expressed as percentage by weight based on the total weight of the ceramic composition, excluding the carbon bond.

The organic binder which decomposes to produce a carbon bond may be for example a phenol-formaldehyde resin such as a novolac or a resol phenol-formaldehyde resin, a urea-formaldehyde resin, a melamine-formaldehyde resin, an epoxy resin, a furane resin or pitch.

The organic binder is preferably a phenol-formaldehyde resin, and it is preferred that the resin is used in the form of a liquid. A powdered phenolic resin can be used but it is necessary to dissolve the resin in a suitable solvent, such as furfural, in order to mix the resin with the other components and produce the ceramic composition. The amount of liquid phenolic resin used will usually be of the order 5-25%, preferably 10-15% by weight, based on the total of the other components, and after production of the ceramic composition, the composition will usually contain 2-12% by weight, preferably of the order of 5% by weight, of carbon produced by decomposition of the resin, based on the total weight of the ceramic composition.

The ceramic compositions of the invention may be produced by first mixing together particles of the boron nitride, the zirconium diboride and the other refractory material, and then adding the liquid resin and mixing until the mixture of the particles and the resin is homogeneous. It may be necessary to heat the mixture to reduce the liquid content of the resin to render the mixture suitable for forming. The mixture is then formed to a desired shape, preferably by cold isostatic pressing of the mixture in a suitable mould. After forming the shape is heated to cure and cross-link the resin, for example at about 150°-300° C. for about 1 hour, and then heated at about 700°-1200° C. to pyrolyse the resin and produce a carbon bond.

Although the ceramic compositions of the invention may be used for other applications, for example in the melting and handling of glass or in the melting, handling and casting of relatively low melting temperature metals such as aluminium and its alloys, the compositions are particularly useful for use in the handling and casting of high melting temperature metals such as iron or steel.

When used in the handling and casting of a metal such as steel each of the three components of the ceramic compositions of the invention confers particular properties on the compositions. The boron nitride makes the compositions non-wetting in the presence of molten steel or molten slag, and hence when used for example in a composition which is used for a casting nozzle will prevent clogging of the nozzle due to alumina build up. In addition the boron nitride makes the compositions resistant to thermal shock, and helps to protect the compositions from oxidation. The zirconium diboride confers erosion resistance, gives protection against oxidation at higher temperatures (up to about 1250° C.) than does the boron nitride, and improves the resistance of the compositions to attack by molten slag. In the preferred embodiments both the aluminium oxide and the zirconium oxide improve the resistance of the composition to attack by molten steel.

In order to increase the oxidation resistance of the compositions at higher temperatures, for example up to about 1400° C., it is desirable to include in the compositions a proportion, for example 5-20% by weight based on the weight of the composition, of silicon carbide and/or titanium diboride, as at least part of the third refractory material.

Examples of applications for the ceramic compositions of the invention in the handling and casting of steel are lining materials, and nozzles and shrouds, such as those used in continuous casting. The zirconium oxide-containing composition described above is particularly suitable for forming that part of a nozzle which in use is at the boundary between the surface of molten steel and molten slag which lies on top of the steel. The aluminium oxide-containing composition described above is particularly suitable for forming the inside of a nozzle, since it can readily be co-pressed with an alumina-graphite material which forms the rest of the nozzle, and it prevents build up of alumina and clogging of the nozzle. While these compositions may be used to form the whole nozzle if desired, it is preferred to use them only to form portions of the nozzles as described. The remainder of the nozzles can then be formed from a conventional carbon bonded ceramic material such as a carbon bonded alumina and graphite mixture.

The following examples will serve to illustrate the invention:

### EXAMPLE 1

A series of compositions was prepared as in Table 1 below. The amount of each of the refractory components is expressed as percentage by weight based on the total, and the amount of liquid resin is expressed as percentage by weight of the total of the refractory components.

TABLE 1

| Composition | | | | | | |
|---|---|---|---|---|---|---|
| No. | BN | ZrB₂ | Al₂O₃ | ZrO₂ | SiC | Resin |
| 1 | 20 | 45 | 35 | — | — | 10 |
| 2 | 25 | 40 | 35 | — | — | 13 |
| 3 | 30 | 35 | 35 | — | — | 15 |
| 4 | 20 | 35 | 45 | — | — | 10 |
| 5 | 30 | 35 | 30 | — | 5 | 15 |
| 6 | 15 | 35 | — | 50 | — | 7 |
| 7 | 15 | 25 | — | 60 | — | 7 |
| 8 | 50 | 35 | — | 15 | — | 20 |

Ceramic compositions according to the invention were produced by first mixing together particulate boron nitride, particulate zirconium diboride and, if present particulate aluminium oxide, zirconium oxide and silicon carbide in an intensive mixer and then adding a liquid phenol-formaldehyde resin, and mixing until the mixture of the particles and the resin was homogeneous.

The boron nitride was a refractory grade containing up to 7% by weight of oxygen and had a particle size of less than 10 microns, and the zirconium diboride had a particle size of less than 45 microns. The aluminium oxide and zirconium oxide were both 50/50 w/w of particles of less than 500 microns and particles of less than 53 microns. The silicon carbide had a particle size of less than 150 microns.

The resin was a liquid novolac phenol-formaldehyde resin having a solids content of 60% by weight.

The mixture of particles and liquid resin was heated to reduce the liquid content of the resin to render the mixture suitable for forming. The mixture was then formed into test specimens by cold isostatic pressing of the mixture in a mould. After forming the specimens were stripped from the mould, and heated for 1 hour at 200° C. heated to cure and cross-link the resin. Finally the test specimens were heated at 900° C. to pyrolyse the resin and produce a carbon bond.

### EXAMPLE 2

Compositions 1, 2, 3, and 4 from Example 1 were tested to assess their resistance to molten steel in comparison with a conventional carbon bonded alumina-graphite material, by measuring their corrosion rate when immersed in molten steel at 1650° C.

Rods 50 mm in diameter and 300 mm in length were made by isostatic pressing using the method described in Example 1, and their diameter was accurately measured. The rods were then held in jigs, and immersed for one hour in molten steel in an induction furnace. At the end of the test the diameter of the rods was remeasured.

The results obtained are tabulated in Table 2 below.

TABLE 2

| Composition No. | Corrosion Rate (mm/hour) |
|---|---|
| 1 | 0.3 |
| 2 | 0.2 |
| 3 | 0.1 |
| 4 | 0.6 |
| Alumina/Graphite | 2 |

### EXAMPLE 3

Compositions 6, 7, and 8 from Example 1 were tested to assess their resistance to molten slag in comparison with a carbon bonded zirconia graphite material, by measuring their corrosion rate when immersed in molten slag at 1580° C.

Rods of the same dimensions as those in Example 1 were made using the method described in Example 1, and their diameter was accurately measured. A borosilicate glass was sprinkled on to the surface of molten steel in an induction furnace, and allowed to melt to form a slag. The rods were then held in jigs and immersed in the molten steel for one hour. At the end of the test the diameter of the rods was remeasured in the area which had been in contact with the molten slag.

The results obtained are shown in Table 3 below.

TABLE 3

| Composition No. | Corrosion Rate (mm/hour) |
|---|---|
| 6 | 2 |
| 7 | 2.5 |
| 8 | 0.5 |
| Zirconia/Graphite | 4 |

### EXAMPLE 4

All eight compositions from Example 1 were tested to assess their resistance to oxidation, by measuring their oxidation rate at 1200° C. at various time intervals.

Disc shaped specimens 30 mm in diameter and 10 mm high were made by the method described in Example 1. The specimens were weighed and placed in an electric oven for various times, and then removed, cooled and reweighed.

The results, which are expressed as weight change of the specimens in mg/mc²/hour, are shown in Table 4 below.

TABLE 4

| Composition No. | 2 Hours | 26 Hours | 130 Hours |
|---|---|---|---|
| 1 | 0.97 | −0.14 | 0.0001 |
| 2 | 2.77 | −0.37 | −0.00005 |
| 3 | 1.74 | −0.60 | −0.00002 |
| 4 | 5.54 | 2.97 | −0.0015 |
| 5 | 0.63 | 0.20 | 0.00001 |
| 6 | 15.10 | 1.89 | 0.00025 |
| 7 | 10.73 | 1.69 | 0.00008 |
| 8 | 0.54 | 0.29 | 0.00003 |

As the results in Table 4 show, the rate of oxidation decreases substantially with time, reaching virtually zero after 130 hours. This can be explained by the phenomenon of passive oxidation which is inherent in the compositions.

### EXAMPLE 5

Compositions 1 and 3 were tested in comparison with a conventional carbon bonded alumina-graphite material to assess their ability to suppress clogging due to alumina build up when used to form the inside surface of a nozzle though which molten steel is cast.

Tubular nozzles having an outside diameter of 50 mm, an inside diameter of 15 mm and a length of 300 m were made using the method described in Example 1. The nozzles were immersed in aluminium killed steel having an aluminium content of 0.2% by weight. After immersion of the nozzles, oxygen was bubbled into the steel and the nozzles were agitated continuously to distribute the oxygen. After 30 minutes the tests were concluded and the nozzles were removed. The nozzles were then sectioned and inspected to assess the build up of alumina.

The alumina-graphite material became badly clogged. Composition 3 showed no clogging, and while composition 1 did show some clogging the material was considerably better than the alumina-graphite material.

### EXAMPLE 6

Four compositions were prepared as in Table 5 below using the method described in Example 1. The boron nitride, zirconium diboride, aluminium oxide and zirconium oxide which were used were the same as those which were used in Example 1. The titanium diboride, boron and calcium hexaboride were powders of particle size less than 50 microns. The magnesium oxide had a particle size of 53 to 500 microns. The amount of each component is expressed in the same manner as in Example 1.

TABLE 5

| | Composition | Composition | Composition | Composition |
|---|---|---|---|---|
| Component | 9 | 10 | 11 | 12 |
| BN | 40 | 20 | 10 | 40 |
| ZrB₂ | 35 | 30 | 35 | 30 |
| TiB₂ | 15 | 15 | 10 | 15 |
| B | 10 | 10 | — | — |
| Al₂O₃ | — | 20 | 10 | — |
| ZrO₂ | — | — | — | 15 |
| CaB₆ | — | 5 | — | — |
| MgO | — | — | 35 | — |
| Resin | 18 | 15 | 15 | 20 |

The compositions were tested to assess their resistance to molten slag using the method described in Example 3, and they were tested to assess their resistance to oxidation using the method described in Example 4.

The results obtained are shown in Table 6 below. The results of the oxidation resistance tests are expressed as weight change of the specimens in mg/cm²/hour.

TABLE 6

| | Corrosion Rate | | | |
|---|---|---|---|---|
| Composition No. | (mm/hour) | 2 Hours | 26 Hours | 130 Hours |
| 9 | 0.4 | 0.3 | 0.2 | 0 |
| 10 | 0.8 | 0.4 | 0.3 | 0 |
| 11 | 0.7 | 20 | 4 | 0.01 |
| 12 | 1 | 0.4 | 0.2 | 0 |

### EXAMPLE 7

A mixture was prepared having the following composition by weight:

| | |
|---|---|
| Boron nitride | 20% |
| Zirconium diboride | 20% |
| Zirconium dioxide | 55% |
| Silicon carbide | 5% |

Each of the four components was as described in Example 1.

The mixture of the ceramic components was mixed with 6.5% by weight, based on the total weight of the four ceramic components, of a liquid novolac phenol-formaldehyde resin having a solids content of 60% by weight as described in Example 1.

Ceramic test specimens in the form of rods 4 cm in diameter and 30 cm in length were then produced using the procedure described in Example 1, and the diameter of the rods was accurately measured.

A slag containing 7% by weight of fluoride was melted on top of molten steel held at 1650° C. in a 250 kg capacity high frequency induction heating furnace.

The rods were then held in jigs, and tested by immersing them in the molten steel for two hours to assess their resistance to thermal shock, the degree of penetration of molten steel and slag, and the rate of corrosion at the slag/metal interface. Similar rods made from a carbon bonded zirconia-graphite material were tested in a similar manner. Both types of rod had adequate thermal shock resistance and resistance to penetration, but the rods made from the composition according to invention was superior in terms of its rate of corrosion at the slag/metal interface. The carbon bonded zirconia-graphite rods had a corrosion rate of 3.05 mm per hour at the slag line whereas the rods made form the composition according to the invention had a corrosion rate of only 0.95 mm per hour.

### EXAMPLE 8

A mixture was prepared having the following composition by weight:

| | |
|---|---|
| Boron nitride | 25% |
| Zirconium diboride | 20% |
| Aluminium oxide | 55% |

Each of the three components was as described in Example 1.

The mixture of the ceramic components was mixed with 7.5% by weight, based on the total weight of the three ceramic components, of a liquid novalac phenol-formaldehyde resin having a solids content of 60% by weight as described in Example 1.

Ceramic test specimens in the form of rods 4 cm in diameter and 30 cm in length were then produced using the procedure described in Example 1.

The rods were then held in jigs and immersed in aluminium killed steel containing 0.05 to 0.1% by weight aluminium in a 250 kg capacity high frequency induction heating furnace. The surface of the molten steel was covered with a layer of rice husks, and in order to prevent excessive oxidation of the steel during the test argon gas was also used to protect the surface of the steel. The temperature of the molten steel was 1570 to 1580° C. and the immersion time was 2 hours. Similar rods made from a carbon bonded alumina-graphite material were tested in a similar manner. At the end of the test the rods made from the composition according to the invention had appreciably less build up of alumina on their surface than did the rods made from the carbon-bonded alumina-graphite material.

1. A ceramic composition characterised in that the composition comprises a mixture of particles of boron nitride, zirconium diboride and at least one other refractory material, bonded together by carbon produced by the decomposition of an organic binder.

2. A ceramic composition, according to claim 1 characterised in that the at least one other refractory material is a refractory metal, an oxide, a carbide, a boride or a nitride.

3. A ceramic composition according to claim 2 characterised in that the refractory metal is boron.

4. A ceramic composition according to claim 2 characterised in that the oxide is one or more of aluminium oxide, zirconium oxide, magnesium oxide, yttrium oxide, calcium oxide, chromium oxide and silicon oxide.

5. A ceramic composition according to claim 2 characterised in that the carbide is one or more of silicon carbide, boron carbide, aluminium carbide and zirconium carbide.

6. A ceramic composition according to claim 2 characterised in that the boride is titanium diboride and/or calcium hexaboride.

7. A ceramic composition according to claim 2 characterised in that the nitride is one or more of silicon nitride, aluminium nitride, titanium nitride, zirconium nitride and sialon.

8. A ceramic composition according to claim 4 characterised in that the composition contains 5-70% by weight of boron nitride, 5-60% by weight of zirconium diboride and 5-80% by weight of zirconium oxide, based on the total weight of the ceramic composition excluding the carbon bond.

9. A ceramic composition according to claim 8 characterised in that the composition contains 15-50% by weight of boron nitride, 15-50% by weight of zirconium diboride and 10-60% by weight of zirconium oxide.

10. A ceramic composition according to claim 4 characterised in that the composition contains 5-70% by weight of boron nitride, 5-60% by weight of zirconium diboride and 10-70% by weight of aluminium oxide, based on the total weight of the ceramic composition excluding the carbon bond.

11. A ceramic composition according to claim 10 characterised in that the composition contains 15-50% by weight of boron nitride, 15-50% by weight of zirconium diboride and 15-60% by weight of aluminium oxide.

12. A ceramic composition according to any one of claims 1 to 11 characterised in that the organic binder is a novalac phenol-formaldehyde resin, a resol phenol-formaldehyde resin, a urea-formaldehyde resin, a melamine-formaldehyde resin, an epoxy resin or pitch.

13. A ceramic composition according to any one of claims 1 to 12 characterised in that the composition contains 2-12% by weight of carbon produced by decomposition of the organic binder.

14. A ceramic composition according to any one of claims 1 to 13 characterised in that at least part of the other refractory material is silicon carbide and/or titanium diboride.

15. A ceramic composition according to claim 14 characterised in that the composition contains 5-20% by weight of silicon carbide and/or titanium diboride.
